(19) United States
(12) Patent Application Publication
(10) Pub. No.: US 2011/0292249 A1
(43) Pub. Date: Dec. 1, 2011

(54) ELECTRONIC CAMERA

(75) Inventors: Hiroshi Sugimoto, Daito-shi (JP); Naoki Yonetani, Daito-shi (JP)

(73) Assignee: SANYO ELECTRIC CO., LTD., Osaka (JP)

(21) Appl. No.: 13/115,375

(22) Filed: May 25, 2011

(30) Foreign Application Priority Data
May 25, 2010 (JP) 2010-118963

(51) Int. Cl. H04N 9/68; H04N 5/228

(52) U.S. Cl. 348/234; 348/222.1; 348/E09.053; 348/E05.031

(57) ABSTRACT

An electronic camera includes an imager. An imager, having an imaging surface capturing a scene, outputs an image. A specific key is transitioned among a non-operated state, a first operated state and a second operated state. A sensor senses the specific key being transitioned from the non-operated state to another state. A setter sets a reference indicating a magnitude different depending on a state of the specific key, in response to a sensing of the sensor. An adjuster adjusts an imaging condition based on the image outputted from the imager. A controller determines whether or not a variation of the scene captured by the imaging surface exceeds the reference set by the setter, so as to permit an adjusting process of the adjuster corresponding to a positive determined result while restrict the adjusting process of the adjuster corresponding to a negative determined result.

### CROSS REFERENCE OF RELATED APPLICATION

The disclosure of Japanese Patent Application No. 2010-118963, which was filed on May 25, 2010, is incorporated here by reference.

### BACKGROUND OF THE INVENTION

1. Field of the Invention

The present invention relates to an electronic camera. More particularly, the present invention relates to an electronic camera which adjusts an imaging condition in response to a key operation.

2. Description of the Related Art

According to one example of this type of a camera, when an autofocus mode is set, the first photographing is performed with an autofocus. However, when a shutter key is fully depressed at once (i.e., in a very short time period) within a predetermined time period after the first photographing, a photographing is performed by directly using a previous (i.e., the first) AF value without autofocus controlling again. Thereby, it becomes possible to photograph a picture in focus without missing a photo-opportunity occurred near a photographed subject after the first photographing.

However, in the above-described camera, upon determining executing or suspending the autofocus controlling, a variation of the subject arisen during the first photographing and the second photographing is not considered. Thus, in the above-described camera, the imaging performance is limited.

### SUMMARY OF THE INVENTION

An electronic camera according to the present invention comprises: an imager, having an imaging surface capturing a scene, which outputs an image; a specific key which is transitioned among a non-operated state, a first operated state and a second operated state; a sensor which senses the specific key being transitioned from the non-operated state to another state; a setter which sets a reference indicating a magnitude different depending on a state of the specific key, in response to a sensing of the sensor; an adjuster which adjusts an imaging condition based on the image outputted from the imager; and a controller which determines whether or not a variation of the scene captured by the imaging surface exceeds the reference set by the setter, so as to permit an adjusting process of the adjuster corresponding to a positive determined result while restrict the adjusting process of the adjuster corresponding to a negative determined result.

According to the present invention, a computer program embodied in a tangible medium, which is executed by a processor of an electronic camera provided with an imager, having an imaging surface capturing a scene, which outputs an image and a specific key which is transitioned among a non-operated state, a first operated state and a second operated state, the program comprises: a sensing instruction to sense the specific key being transitioned from the non-operated state to another state; a setting instruction to set a reference indicating a magnitude different depending on a state of the specific key, in response to a sensing based on the sensing instruction; an adjusting instruction to adjust an imaging condition based on the image outputted from the imager; and a controlling instruction to determine whether or not a variation of the scene captured by the imaging surface exceeds the reference set based on the setting instruction, so as to permit an adjusting process of the adjusting instruction corresponding to a positive determined result while restrict the adjusting process of the adjusting instruction corresponding to a negative determined result.

According to the present invention, an imaging control method executed by an electronic camera provided with an imager, having an imaging surface capturing a scene, which outputs an image and a specific key which is transitioned among a non-operated state, a first operated state and a second operated state, the imaging control method, comprises: a sensing step of sensing the specific key being transitioned from the non-operated state to another state; a setting step of setting a reference indicating a magnitude different depending on a state of the specific key, in response to a sensing of the sensing step; an adjusting step of adjusting an imaging condition based on the image outputted from the imager; and a controlling step of determining whether or not a variation of the scene captured by the imaging surface exceeds the reference set by the setting step, so as to permit an adjusting process of the adjusting step corresponding to a positive determined result while restrict the adjusting process of the adjusting step corresponding to a negative determined result.

According to the present invention, an external control program supplied to an electronic camera provided with an imager, having an imaging surface capturing a scene, which outputs an image; a specific key which is transitioned among a non-operated state, a first operated state and a second operated state; and a processor which executes a process according to an internal control program stored in a memory, the external control program causing the processor to execute, in cooperation with the internal control program, a sensing step of sensing the specific key being transitioned from the non-operated state to another state, a setting step of setting a reference indicating a magnitude different depending on a state of the specific key, in response to a sensing of the sensing step, an adjusting step of adjusting an imaging condition based on the image outputted from the imager and a controlling step of determining whether or not a variation of the scene captured by the imaging surface exceeds the reference set by the setting step, so as to permit an adjusting process of the adjusting step corresponding to a positive determined result while restrict the adjusting process of the adjusting step corresponding to a negative determined result.

An electronic camera according to the present invention provided with an imager, having an imaging surface capturing a scene, which outputs an image; a specific key which is transitioned among a non-operated state, a first operated state and a second operated state; a taker which takes an external control program; and a processor which executes a process according to the external control program taken by the taker and an internal control program stored in a memory, wherein the external control program is equivalent to a program which executes, in cooperation with the internal control program, a sensing step of sensing the specific key being transitioned from the non-operated state to another state, a setting step of setting a reference indicating a magnitude different depending on a state of the specific key, in response to a sensing of the sensing step, an adjusting step of adjusting an imaging condition based on the image outputted from the imager and a controlling step of determining whether or not a variation of the scene captured by the imaging surface exceeds the reference set by the setting step, so as to permit an adjusting process of the adjusting step corresponding to a positive determined result while restrict the adjusting process of the adjusting step corresponding to a negative determined result.

The above described features and advantages of the present invention will become more apparent from the following detailed description of the embodiment when taken in conjunction with the accompanying drawings.

### BRIEF DESCRIPTION OF THE DRAWINGS

FIG. 1 is a block diagram showing a basic configuration of one embodiment of the present invention;

FIG. 2 is a block diagram showing a configuration of one embodiment of the present invention;

FIG. 3 is an illustrative view showing one example of an allocation state of an evaluation area in an imaging surface;

FIG. 4 (A) is a timing chart showing one portion of behavior in the embodiment in FIG. 2;

FIG. 4 (B) is a timing chart showing another portion of behavior in the embodiment in FIG. 2;

FIG. 4 (C) is a timing chart showing still another portion of behavior in the embodiment in FIG. 2;

FIG. 5 (A) is a graph showing one portion of behavior in the embodiment in FIG. 2;

FIG. 5 (B) is a graph showing another portion of behavior in the embodiment in FIG. 2;

FIG. 6 is a flowchart showing one portion of behavior of a CPU applied to the embodiment in FIG. 2;

FIG. 7 is a flowchart showing another portion of the behavior of the CPU applied to the embodiment in FIG. 2;

FIG. 8 is a flowchart showing still another portion of the behavior of the CPU applied to the embodiment in FIG. 2;

FIG. 9 is a flowchart showing yet another portion of the behavior of the CPU applied to the embodiment in FIG. 2; and

FIG. 10 is a block diagram showing a configuration of another embodiment of the present invention.

### DETAILED DESCRIPTION OF THE PREFERRED EMBODIMENTS

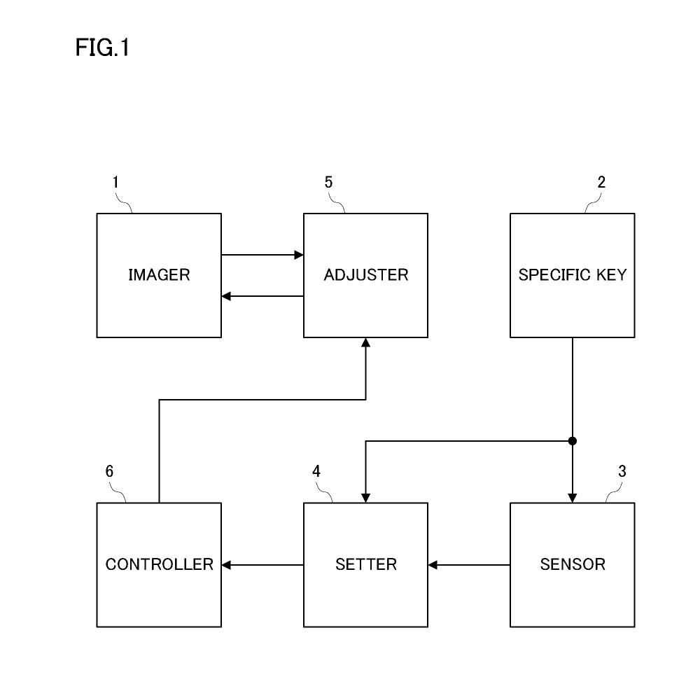

With reference to FIG. 1, an electronic camera according to one embodiment of the present invention is basically configured as follows: An imager 1, having an imaging surface capturing a scene, outputs an image. A specific key 2 is transitioned among a non-operated state, a first operated state and a second operated state. A sensor 3 senses the specific key being transitioned from the non-operated state to another state. A setter 4 sets a reference indicating a magnitude different depending on a state of the specific key 2, in response to a sensing of the sensor 3. An adjuster 5 adjusts an imaging condition based on the image outputted from the imager 1. A controller 6 determines whether or not a variation of the scene captured by the imaging surface exceeds the reference set by the setter 4, so as to permit an adjusting process of the adjuster 5 corresponding to a positive determined result while restrict the adjusting process of the adjuster 5 corresponding to a negative determined result.

When the specific key 2 is transitioned from the non-operated state to the first operated state or the second operated state, the reference is set. The magnitude of the reference differs depending on whether a transition destination is either the first operated state or the second operated state. The adjusting process for the imaging condition is permitted when the variation of the scene exceeds the reference, and is restricted when the variation of the scene is equal to or less than the reference. That is, the adjusting process for the imaging condition is permitted or restricted by considering an operation manner of the specific key 2 and the variation of the scene. Thereby, an imaging performance is improved.

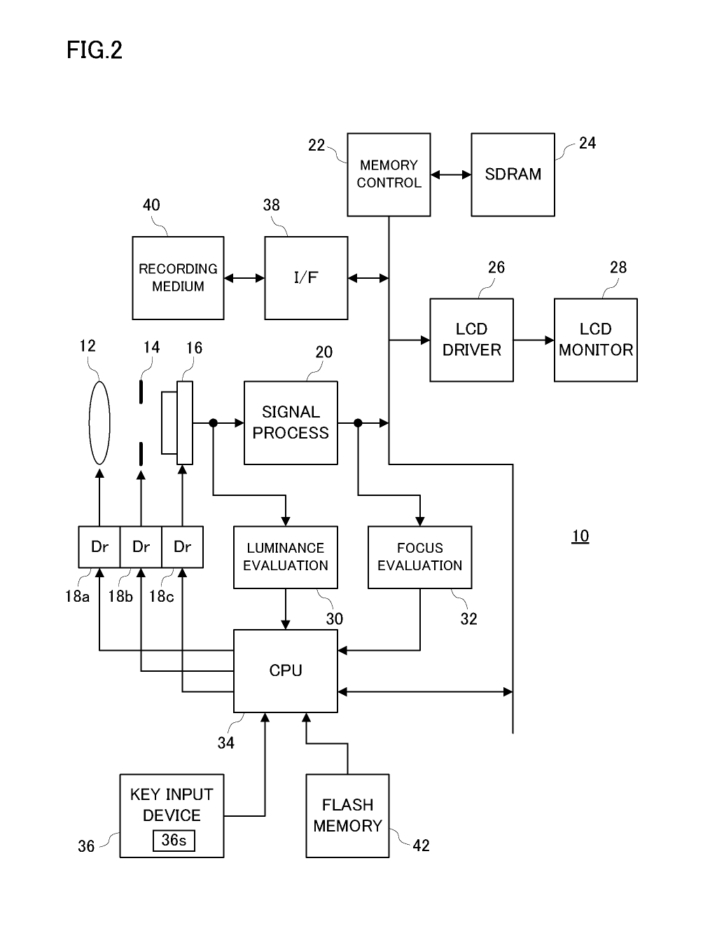

With reference to FIG. 2, a digital camera 10 according to one embodiment includes a focus lens 12 and an aperture unit 14 driven by drivers 18a and 18b, respectively. An optical image of the scene that underwent the focus lens 12 and the aperture unit 14 enters, with irradiation, the imaging surface of an imaging device 16.

A plurality of light receiving elements (=pixels) are placed two-dimensionally on the imaging surface, and the imaging surface is covered with a primary color filter having a Bayer array (not shown). The light receiving elements placed on the imaging surface correspond one by one to filter factors configuring the color filter, and an amount of electric charges produced by each light receiving element reflects an intensity of light corresponding to color of R, (or B.

When a power source is applied, a CPU 34 commands a driver 18c to repeat an exposure procedure and an electric-charge reading-out procedure in order to execute a moving-image taking process. In response to a vertical synchronization signal Vsync outputted from an SG (Signal Generator) not shown, the driver 18c exposes the imaging surface and reads out the electric charges produced thereby in a raster scanning manner. From the imaging device 16, raw image data that is based on the read-out electric charges is cyclically outputted. The outputted raw image data is equivalent to image data in which each pixel has color information of any one of R, G, and B.

A signal processing circuit 20 creates RGB-formatted image data in which each pixel has all the color information items of R, G, and B by performing a color separation process on the raw image data outputted from the imaging device 16, performs a white balance adjusting process on the created image data, and then, converts a format of the image data having the adjusted white balance to a YUV format. The converted YUV-formatted image data is written into an SDRAM 24 through a memory control circuit 22.

An LCD driver 26 repeatedly reads out the image data accommodated in the SDRAM 24 through the memory control circuit 22, and drives an LCD monitor 28 based on the read-out image data. As a result, a moving image (the live view image) representing the scene is displayed on a monitor screen.

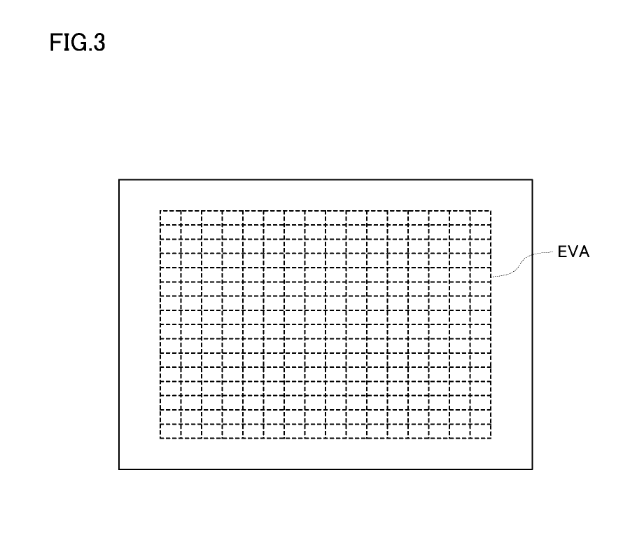

With reference to FIG. 3, an evaluation area EVA is allocated to a center of the imaging surface. The evaluation area EVA is divided into 16 portions in each of a horizontal direction and a vertical direction; therefore, 256 divided areas form the evaluation area EVA.

A luminance evaluating circuit 30 integrates the raw image data outputted from the imaging device 16 for each divided area, and outputs 256 integral values (256 luminance evaluation values). A focus evaluating circuit 32 integrates a high-frequency component of Y data produced by a YUV conversion for each divided area, and outputs 256 integral values (256 focus evaluation values). These integral processes are executed every time the vertical synchronization signal Vsync is generated, and in response to the vertical synchronization signal Vsync, the luminance evaluation value and the focus evaluation value are outputted from the luminance evaluating circuit 30 and the focus evaluating circuit 32.

A shutter button 36s arranged in a key input device 36 is transitioned among states ST0 to ST2. “ST0” is equivalent to the non-operated state, “ST1” is equivalent to a half-depressed state, and “ST2” is equivalent to a fully-depressed state. Thus, the shutter button 36s is transitioned from the state ST0 to the state ST2 via the state ST1.

When the shutter button 36s is in the state ST0, the CPU 34 repeatedly executes a simple AE process in order to calculate an appropriate EV value based on the luminance evaluation value outputted from the luminance evaluating circuit 30. An aperture amount and an exposure time period that define the calculated appropriate EV value are set to the drivers 18b and 18c, respectively, and thereby, a brightness of the live view image is adjusted approximately.

When the shutter button 36s is transitioned from the state ST0 to another state, the CPU 34 permits or restricts to execute a strict AE process and an AF process by considering an operation manner of the shutter button 36s and the variation of the scene captured by the imaging surface.

The strict AE process is executed with reference to a plurality of luminance evaluation values outputted from the luminance evaluating circuit 30, and thereby, an optimal EV value is calculated. An aperture amount and an exposure time period that define the calculated optimal EV value are also set to the drivers 18b and 18c, respectively, and thereby, the brightness of the live view image is adjusted to an optimal value.

In parallel with a movement of the focus lens 12, the AF process is executed with reference to a plurality of the focus evaluation values outputted from the focus evaluating circuit 32. A focal point is searched by noticing a change of the plurality of focus evaluation values, and the focus lens 12 is placed at thus discovered focal point. Thereby, a sharpness of the live view image is improved.

When the shutter button 36s is transitioned to the state ST2, the CPU 34 executes a still-image taking process. One frame of image data representing the scene at a time point at which the shutter button 36s is transitioned to the state ST2 is evacuated to a work area (not shown) arranged in the SDRAM 24. Upon completion of the still-image taking process, the CPU 34 starts up an I/F 38 for a recording process. The I/F 38 reads out the image data evacuated to the work area through the memory control circuit 22 so as to record the read-out image data in a recording medium 40 in a file format.

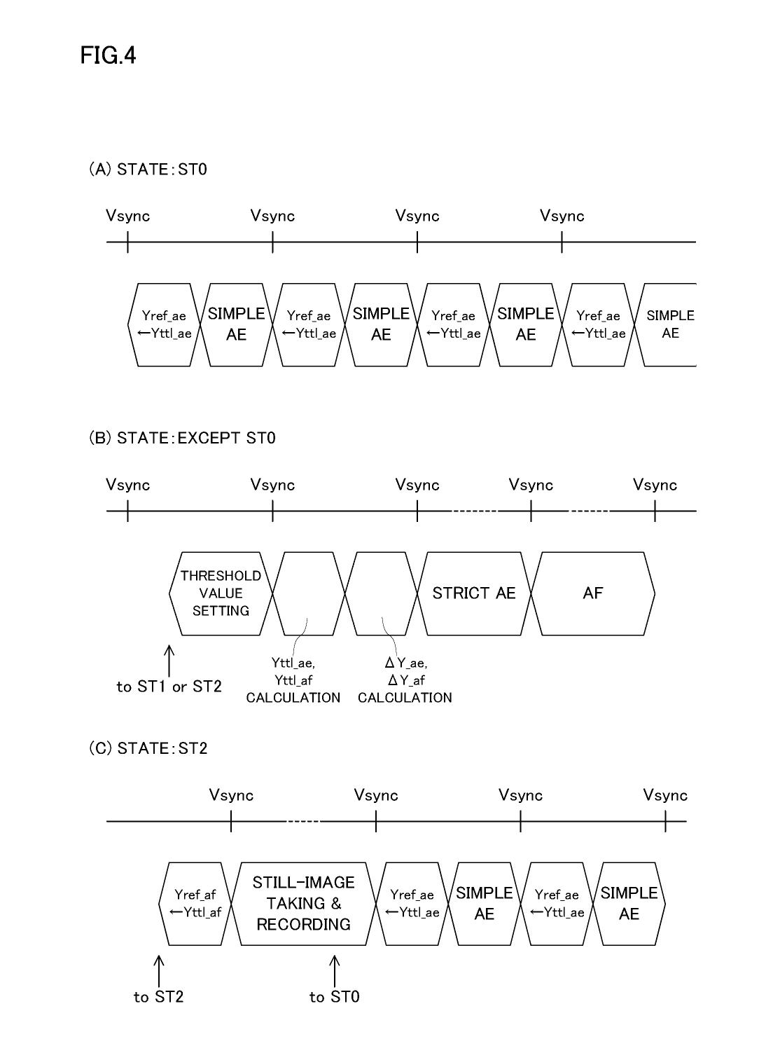

With reference to FIG. 4 (A) to FIG. 4 (C), permitting or restricting the strict AE process and the AF process is controlled according to the following procedure.

When the shutter button 36s is in the state ST0, a process of setting a total luminance Yttl_ae equivalent to a total sum of the 256 luminance evaluation values outputted from the luminance evaluating circuit 30 to a reference value Yref_af is repeatedly executed in parallel with the above-described simple AE process. When the shutter button 36s having been transitioned to a state different from the state ST0 is sensed, the transition destination is further sensed so as to set threshold values TH_ae and TH_af with a procedure different depending on the sensed transition destination.

With reference to FIG. 5 (A) to FIG. 5 (B) additionally, when the sensed transition destination is the state ST1, the threshold value TH_ae is set to “Kae1”, and the threshold value TH_af is set to “Kaf1”. On the other hand, when the sensed transition destination is the state ST2, the threshold value TH_ae is set to “Kae2”, and the threshold value TH_af is set to “Kaf2”.

Here, the coefficient Kae2 is larger than the coefficient Kae1, and the coefficient Kaf2 is larger than the coefficient Kaf1. Moreover, the coefficients Kae2 and Kaf2 are selected when the shutter button 36s is fully depressed at once, i.e., when the shutter button 36s is transitioned from the non-operated state to the fully-depressed state in a very short time.

Upon completion of setting the threshold values TH_ae and TH_af, the total sum of the 256 luminance evaluation values outputted from the luminance evaluating circuit 30 thereafter is calculated as the total luminance Yttl_ae. Moreover, a total sum of 256 weighted values obtained by performing a predetermined weighting to the same 256 luminance evaluation values is calculated as a total luminance Yttl_af. The total luminance Yttl_ae is applied to Equation 1 for calculating a luminance change amount ΔY_ae, and the total luminance Yttl_af is applied to Equation 2 for calculating a luminance change amount ΔY_af.

ΔY_{—}ae=|Yref_{—}ae−Yttl_{—}ae| [Equation 1]

ΔY_{—}af=|Yref_{—}af−Yttl_{—}af| [Equation2]

Here, “Yref_ae” is equivalent to the total luminance Yttl_ae which is calculated immediately before the shutter button 36s is transitioned from the state ST0 to another state. Thus, the luminance change amount ΔY_ae represents a change amount of the total luminance Yttl_ae before and after the shutter button 36s is transitioned from the state ST0 to another state. Since the simple AE process is repeated in parallel with calculating the total luminance Yttl_ae, the luminance change amount ΔY_ae is regarded as one of parameters defining the variation of the scene captured by the imaging surface.

Moreover, “Yref_af” is equivalent to the total luminance Yttl_af which is calculated immediately after the shutter button 36s is transitioned from the state ST0 to another state. However, as shown in FIG. 4 (C), a process of setting the total luminance Yttl_af to the reference value Yref_af is executed on the condition that the shutter button 36s is transitioned to the state ST2. Thus, the luminance change amount ΔY_af represents a difference between the total luminance Yttl_af calculated in association with fully depressing the shutter button 36s last time and the total luminance Yttl_af calculated in association with fully depressing the shutter button 36s this time. The luminance change amount ΔY_af thus obtained is also regarded as one of the parameters defining the variation of the scene captured by the imaging surface.

The strict AE process is permitted when the luminance change amount ΔY_ae calculated according to Equation 1 exceeds the threshold value TH_ae set according to the above-described procedure. Moreover, the AF process is permitted when the luminance change amount ΔY_af calculated according to Equation 2 exceeds the threshold value TH_af set according to the above-described procedure. In other words, the strict AE process is restricted when the luminance change amount ΔY_ae is equal to or less than the threshold value TH_ae, and the AF process is restricted when the luminance change amount ΔY_af is equal to or less than the threshold value TH_af.

As can be seen from FIG. 5 (A) to FIG. 5 (B), a magnitude of the threshold value TH_ae set corresponding to the transition from the state ST0 to the state ST2 exceeds a magnitude of the threshold value TH_ae set corresponding to the transition from the state ST0 to the state ST1. Similarly, a magnitude of the threshold value TH_af set corresponding to the transition from the state ST0 to the state ST2 exceeds a magnitude of the threshold value TH_af set corresponding to the transition from the state ST0 to the state ST1.

Thus, a reference in which the strict AE process and the AF process are permitted becomes higher corresponding to the transition from the state ST0 to the state ST2 while becomes lower corresponding to the transition from the state ST0 to the state ST1. That is, when half-depressing the shutter button 36s is sensed, the strict AE process and the AF process tend to be easily permitted while when depressing the shutter button 36s at once is sensed, these processes tend to be hard to permit.

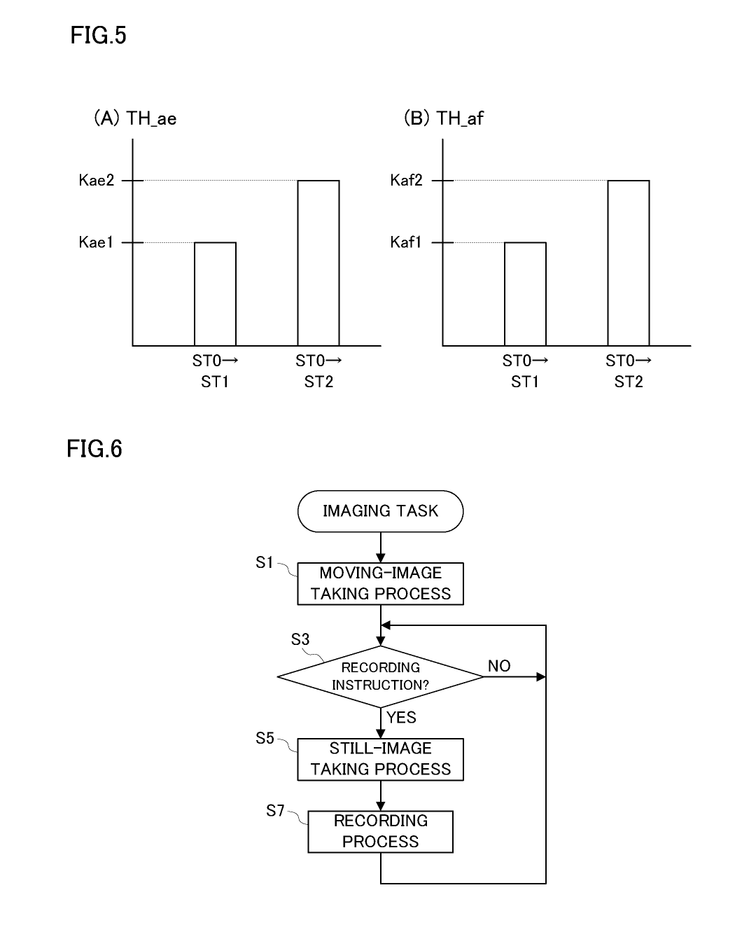

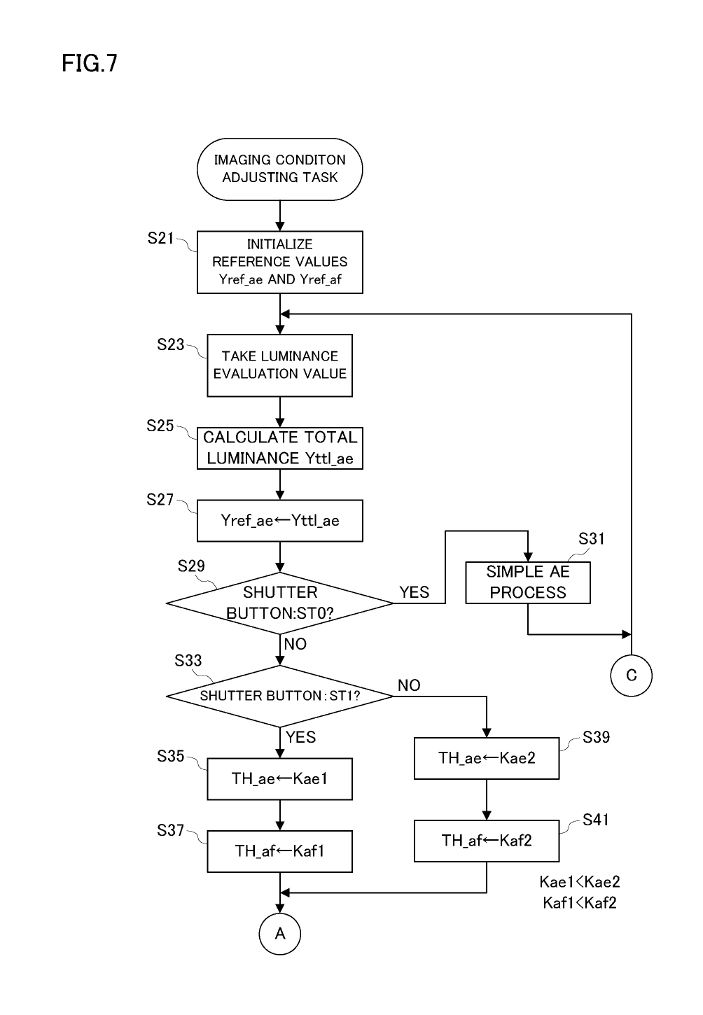

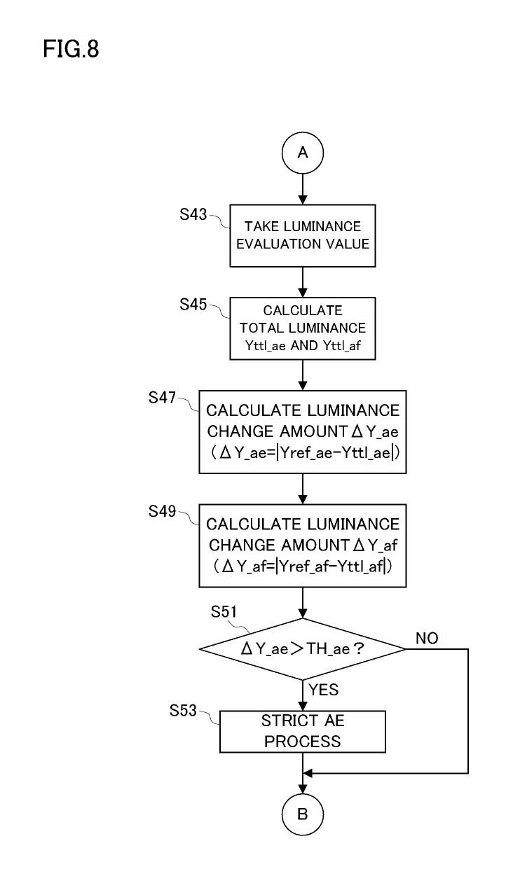

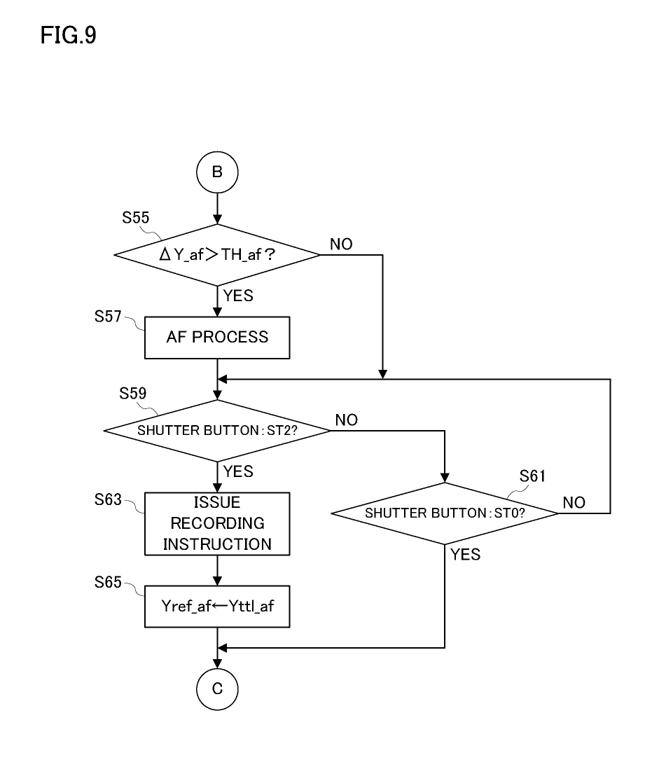

Under a multi task operating system such as the μlTRON, the CPU 34 executes a plurality of tasks including an imaging task shown in FIG. 6 and an imaging condition adjusting task shown in FIG. 7 to FIG. 9, in a parallel manner. It is noted that control programs corresponding to the multi task operating system and the plurality of tasks are stored in a flash memory 42.

With reference to FIG. 6, in a step 1, the moving-image taking process is executed. As a result, the live view image representing the scene is displayed on the LCD monitor 28. In a step S3, it is determined whether or not a recording instruction is issued, and when a determined result is updated from NO to YES, the process advances to a step S5. In the step S5, the still-image taking process is executed, and in a subsequent step S7, the recording process is executed. Thereby, the image data representing the scene at a time point at which the shutter button 36s is fully depressed is recorded in the recording medium 40 in a file format. Upon completion of the recording process, the process returns to the step S3.

With reference to FIG. 7, in a step S21, the reference values Yref_ae and Yref_af are initialized, and in a step S23, the 256 luminance evaluation values outputted from the luminance evaluating circuit 30 are taken. In a step S25, a total sum of the taken 256 luminance evaluation values is calculated as the total luminance Yttl_ae, and in a step S27, the calculated total luminance Yttl_ae is set to the reference value Yref_ae.

In a step S29, it is determined whether or not the state of the shutter button 36s is “ST0”. When a determined result is YES, i.e., when the shutter button 36s maintains the state ST0, the process advances to a step S31 so as to execute the simple AE process with reference to the luminance evaluation values taken in the step S23. As a result, the brightness of the live view image is adjusted approximately. Upon completion of the simple AE process, the process returns to the step S23.

When a determined result of the step S29 is NO, it is regarded that the state of the shutter button 36s is transitioned from “ST0” to “ST1” or “ST2”, and the process advances to a step S33. In the step S33, it is determined whether the transition destination is either the state ST1 or the state ST2 so as to execute processes in steps S35 to S37 corresponding to a determined result indicating the state ST1 while execute processes in steps S39 to S41 corresponding to the determined result indicating the state ST2.

When the state of the shutter button 36s is “ST0” at a time point of the process in the step S29, the process in the step S29 is executed again via the steps S31, S23 to S27. When the state of the shutter button 36s is “ST2” at this time point, the process advances to the step S39 via the step S33.

That is, the process advances to the step S39 when the state of the shutter button 36s is transitioned from “ST0” to “ST2” in a very short time (when “depressing at once” of the shutter button 36s is performed).

In the step S35, the coefficient Kae1 is set to the threshold value TH_ae, and in a step S37, the coefficient Kaf1 is set to the threshold value TH_af. In the step S39, the coefficient Kae2 is set to the threshold value TH_ae, and in the step S41, the coefficient Kaf2 is set to the threshold value TH_af.

In a step S43, the 256 luminance evaluation values outputted from the luminance evaluating circuit 30 are taken. In a subsequent step S45, the total sum of the taken 256 luminance evaluation values is calculated as the total luminance Yttl_ae, and concurrently, the total sum of 256 weighted values obtained by performing the predetermined weighting to the same 256 luminance evaluation values is calculated as the total luminance Yttl_af. In a step S47, the luminance change amount ΔY_ae is calculated according to Equation 1, and in a step S49, the luminance change amount ΔY_af is calculated according to Equation 2.

In a step S51, it is determined whether or not the luminance change amount ΔY_ae exceeds the threshold value TH_ae. When a determined result is YES, the strict AE process is executed in a step S53, and thereafter, the process advances to a step S55 while when the determined result is NO, the process directly advances to the step S55. In the step S55, it is determined whether or not the luminance change amount ΔY_af exceeds the threshold value TH_af. When a determined result is YES, the AF process is executed in a step S57, and thereafter, the process advances to a step S59 while when the determined result is NO, the process directly advances to the step S59. The brightness of the live view image is adjusted to the optimal value by the strict AE process, and the sharpness of the live view image is improved by the AF process.

In the step S59, it is determined whether or not the state of the shutter button 36s is “ST2”, and in a step S61, it is determined whether or not the state of the shutter button 36s is “ST0”. When a determined result of the step S59 is YES, the recording instruction is issued in a step S63, the total luminance Yttl_af calculated in the step S45 is set to the reference value Yref_af in a step S65, and thereafter, the process returns to the step S23. On the other hand, when YES is determined in the step S61, the process directly returns to the step S23 while when NO is determined both in the steps S59 and S61, the process returns to the step S59.

As can be seen from the above-described explanation, the imaging device 16 has the imaging surface capturing the scene, and repeatedly outputs the scene image. The shutter button 36s is transitioned among the non-operated state, the half-depressed state and the fully-depressed state. The CPU 34 senses the shutter button 36s being transitioned from the non-operated state to another state (S29), and sets the threshold values TH_ae and TH_af to the magnitudes different depending on the state of the shutter button 36s (S33 to S41). Moreover, the CPU 34 calculates the luminance change amounts ΔY_ae and ΔY_af as the parameters indicating the variation of the scene captured by the imaging surface (S47, S49), executes the strict AE process when the luminance change amount ΔY_ae exceeds the threshold value TH_ae, and concurrently, executes the AF process when the luminance change amount ΔY_af exceeds the threshold value TH_af (S51 to S57). When the shutter button 36s is transitioned to the fully-depressed state, the CPU 34 records the scene image outputted from the imaging device 16 in the recording medium 40 (S63, S7).

Thus, when the shutter button 36s is transitioned from the non-operated state to the half-depressed state or the fully-depressed state, the threshold values TH_ae and TH_af are set. The magnitudes of the threshold values TH_ae and TH_af differ depending on whether the transition destination is either the half-depressed state or the fully-depressed state. The strict AE process is permitted when the luminance change amount ΔY_ae exceeds the threshold value TH_ae, and the AF process is permitted when the luminance change amount ΔY_af exceeds the threshold value TH_af. In other words, the strict AE process is restricted when the luminance change amount ΔY_ae is equal to or less than the threshold value TH_ae, and the AF process is restricted when the luminance change amount ΔY_af is equal to or less than the threshold value TH_af. That is, the strict AE process and the AF process are executed or restricted by considering the operation manner of the shutter button 36s and the variation of the scene. Thereby, the imaging performance is improved.

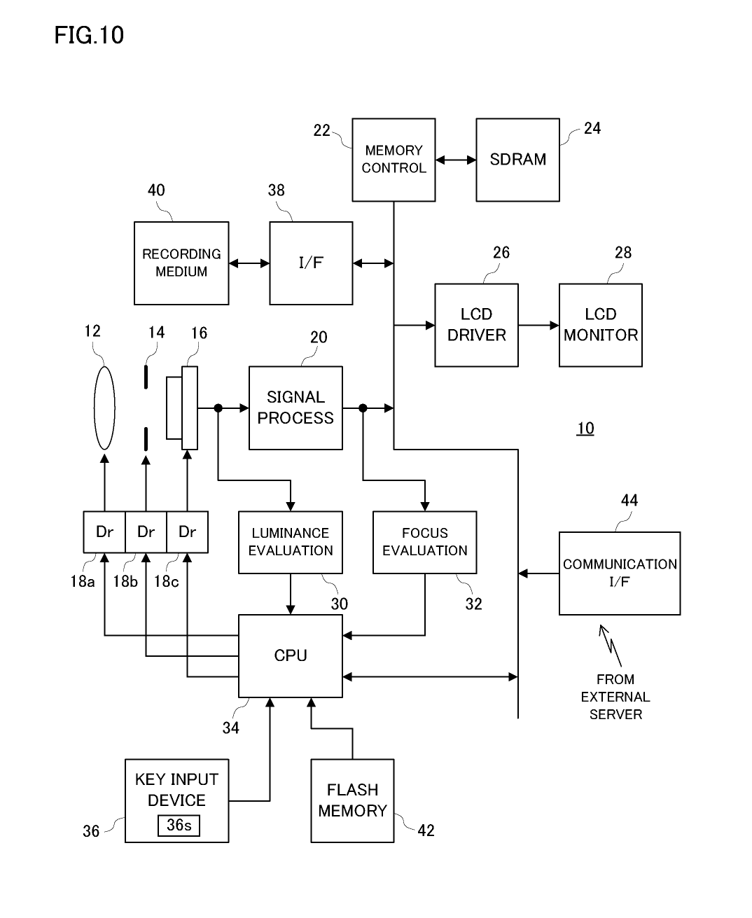

It is noted that, in this embodiment, the control programs equivalent to the multi task operating system and the plurality of tasks executed thereby are previously stored in the flash memory 42. However, as shown in FIG. 10, a communication I/F 44 may be arranged in the digital camera 10 so as to initially prepare a part of the control programs in the flash memory 42 as an internal control program while acquire another part of the control programs from an external server as an external control program. In this case, the above-described procedures are realized in cooperation with the internal control program and the external control program.

Moreover, in this embodiment, the processes executed by the CPU 34 are divided into the imaging task shown in FIG. 6 and the imaging condition adjusting task shown in FIG. 7 to FIG. 9. However, the imaging condition adjusting task may be further divided into a plurality of small tasks, and furthermore, a part of the divided small tasks may be integrated into the imaging task. Moreover, when the imaging condition adjusting task is divided into the plurality of the small tasks, the whole task or a part of the task may be acquired from the external server.

Furthermore, in this embodiment, the shutter button 36s is transitioned from the state ST0 to the state ST2, always via the state ST1. However, a lever in which the state ST0 is allocated to a center and the states ST1 and ST2 are allocated to both ends respectively may be installed instead of the shutter button 36s. In this case, the lever is directly transitioned to the state ST2 bypassing the state ST1.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An electronic camera, comprising:
an imager, having an imaging surface capturing a scene, which outputs an image;
a specific key which is transitioned among a non-operated state, a first operated state and a second operated state;
a sensor which senses said specific key being transitioned from the non-operated state to another state;
a setter which sets a reference indicating a magnitude different depending on a state of said specific key, in response to a sensing of said sensor;
an adjuster which adjusts an imaging condition based on the image outputted from said imager; and
a controller which determines whether or not a variation of the scene captured by said imaging surface exceeds the reference set by said setter, so as to permit an adjusting process of said adjuster corresponding to a positive determined result while restrict the adjusting process of said adjuster corresponding to a negative determined result.

2. An electronic camera according to claim 1, further comprising a recorder which records the image outputted from said imager when said specific key is transitioned to the second operated state.

3. An electronic camera according to claim 1, wherein said specific key is equivalent to a key which is transitioned from the non-operated state to the second operated state via the first operated state.

4. An electronic camera according to claim 1, wherein said setter includes a first reference setter which sets the magnitude of the reference to a first magnitude corresponding to the first operated state and a second reference setter which sets the magnitude of the reference to a second magnitude exceeding the first size corresponding to the second operated state.

5. An electronic camera according to claim 1, further comprising:
a luminance adjuster which repeatedly adjusts a luminance of the image outputted from said imager when said specific key is in the non-operated state; and
a first detector which detects an amount of changing in luminance of the images outputted from said imager before and after the sensing of said sensor as at least a part of parameters defining the variation of the scene captured on said imaging surface, wherein the reference set by said setter includes an exposure-related reference, the imaging condition adjusted by said adjuster includes an exposure amount of said imaging surface, and said controller includes a first comparer which compares the amount of changing in luminance detected by said first detector with the exposure-related reference.

6. An electronic camera according to claim 1, further comprising:
a focus lens which is arranged in front of said imaging surface;
a second detector which detects a difference between the luminance of the image outputted from said imager at a timing corresponding to the sensing of said sensor and a reference luminance as at least a part of the parameters defining the variation of the scene captured on said imaging surface; and
an updater which updates the reference luminance to a luminance noticed by said second detector in association with a recording process of said recorder, wherein the reference set by said setter includes a focus-related reference, the imaging condition adjusted by said adjuster includes a distance from said focus lens to said imaging surface, and said controller includes a second comparer which compares the difference detected by said second detector with the focus-related reference.

7. A computer program embodied in a tangible medium, which is executed by a processor of an electronic camera provided with an imager, having an imaging surface capturing a scene, which outputs an image and a specific key which is transitioned among a non-operated state, a first operated state and a second operated state, said program comprising:
a sensing instruction to sense said specific key being transitioned from the non-operated state to another state;
a setting instruction to set a reference indicating a magnitude different depending on a state of said specific key, in response to a sensing based on said sensing instruction;
an adjusting instruction to adjust an imaging condition based on the image outputted from said imager; and
a controlling instruction to determine whether or not a variation of the scene captured by said imaging surface exceeds the reference set based on said setting instruction, so as to permit an adjusting process of said adjusting instruction corresponding to a positive determined result while restrict the adjusting process of said adjusting instruction corresponding to a negative determined result.

8. An imaging control method executed by an electronic camera provided with an imager, having an imaging surface capturing a scene, which outputs an image and a specific key which is transitioned among a non-operated state, a first operated state and a second operated state, said imaging control method, comprising:
a sensing step of sensing said specific key being transitioned from the non-operated state to another state;
a setting step of setting a reference indicating a magnitude different depending on a state of said specific key, in response to a sensing of said sensing step;
an adjusting step of adjusting an imaging condition based on the image outputted from said imager; and
a controlling step of determining whether or not a variation of the scene captured by said imaging surface exceeds the reference set by said setting step, so as to permit an adjusting process of said adjusting step corresponding to a positive determined result while restrict the adjusting process of said adjusting step corresponding to a negative determined result.

9. An external control program supplied to an electronic camera provided with an imager, having an imaging surface capturing a scene, which outputs an image; a specific key which is transitioned among a non-operated state; a first operated state and a second operated state; and a processor which executes a process according to an internal control program stored in a memory, said external control program causing said processor to execute, in cooperation with the internal control program:
a sensing step of sensing said specific key being transitioned from the non-operated state to another state;
a setting step of setting a reference indicating a magnitude different depending on a state of said specific key, in response to a sensing of said sensing step;
an adjusting step of adjusting an imaging condition based on the image outputted from said imager; and
a controlling step of determining whether or not a variation of the scene captured by said imaging surface exceeds the reference set by said setting step, so as to permit an adjusting process of said adjusting step corresponding to a positive determined result while restrict the adjusting process of said adjusting step corresponding to a negative determined result.

10. An electronic camera provided with an imager, having an imaging surface capturing a scene, which outputs an image; a specific key which is transitioned among a non-operated state, a first operated state and a second operated state; a taker which takes an external control program; and
a processor which executes a process according to the external control program taken by said taker and an internal control program stored in a memory, wherein
said external control program is equivalent to a program which executes, in cooperation with said internal control program:
a sensing step of sensing said specific key being transitioned from the non-operated state to another state;
a setting step of setting a reference indicating a magnitude different depending on a state of said specific key, in response to a sensing of said sensing step;
an adjusting step of adjusting an imaging condition based on the image outputted from said imager; and
a controlling step of determining whether or not a variation of the scene captured by said imaging surface exceeds the reference set by said setting step, so as to permit an adjusting process of said adjusting step corresponding to a positive determined result while restrict the adjusting process of said adjusting step corresponding to a negative determined result.
